(19) United States
(12) Patent Application Publication
(10) Pub. No.: US 2026/0073448 A1
(43) Pub. Date: Mar. 12, 2026

(54) DEVICE AND METHOD FOR PROVIDING FINANCIAL INDEX ANALYSIS-BASED INVESTMENT VALUE EVALUATION SERVICE

(71) Applicant: HORIZON TECHNOLOGIES INC., Seoul (KR)

(72) Inventors: Dong Hyun CHO, Seoul (KR); Il PARK, Hanam-si Gyeonggi-do (KR); Si Woo YU, Namyangju-si Gyeonggi-do (KR)

(21) Appl. No.: 18/853,109

(22) PCT Filed: May 11, 2023
(86) PCT No.: PCT/KR2023/006412

§ 371 Date: May 14, 2025

(30) Foreign Application Priority Data
Jun. 24, 2022 (KR) 10-2022-0077233
Jun. 24, 2022 (KR) 10-2022-0077234
Jun. 24, 2022 (KR) 10-2022-0077235
Jun. 24, 2022 (KR) 10-2022-0077236
Jun. 24, 2022 (KR) 10-2022-0077237
Jun. 24, 2022 (KR) 10-2022-0077238
Jun. 24, 2022 (KR) 10-2022-0077239

(51) Int. Cl. G06Q 40/04

(52) U.S. Cl. CPC G06Q 40/0421

(57) ABSTRACT

A device of providing an investment value evaluation service according to one embodiment of the present disclosure may include a preprocessing module that processes financial data for each company or asset collected from a market server to generate training data including figures for each preset financial indicator; an analysis module that is constructed through the training of a preset machine learning model using the training data to predict a value evaluation index for each company or asset, and output analysis data based on the predicted value evaluation index; and a service providing module that processes analysis data for a specific company or asset output from the analysis module according to an analysis request from a user terminal to provide investment value evaluation data to the user terminal, wherein the value evaluation index is a fair price representing an upside potential in the value of a company or asset according to the figures for each financial indicator compared to a current price.

### TECHNICAL FIELD

The present disclosure relates to a method and device of providing an investment value evaluation service, and more particularly, to a technology of analyzing indicators in financial data for companies or assets from various perspectives using machine learning, and providing an investment analysis and value evaluation service based thereon.

### BACKGROUND ART

In recent years, while individuals' investments in financial assets such as stocks and cryptocurrencies have been rapidly increasing, a phenomenon is occurring in which the actual returns of new investors remain negative compared to the market. In response to the phenomenon, investment methods that were once exclusive to institutions or experts are spreading to individual investors, and a representative example thereof is a quant investment.

A quant investment, a compound word of ‘quantitative’ and ‘analyst’, is a method of investment that utilizes various indicators representing the financial status of a company or financial asset. That is, it is an advanced investment method that establishes a trading strategy through a quantitative analysis of objective numerical indicators provided by companies or securities firms.

First, information provided by companies is generally data about their financial statuses, sales activities, and earnings positions, which are recorded in financial statements. Therefore, through the financial statements, it may be determined whether a company is generating profits efficiently, is a healthy company with sufficient cash reserves, or is a distressed company with a lot of debt. That is, the financial statements may be utilized as key data for assessing investment risks and establishing investment strategies.

However, because understanding financial statements requires specialized accounting knowledge, there is a problem in that it is difficult for general individual investors to understand their meaning. For example, in order to determine whether a company is insolvent, one must directly calculate various financial ratios such as a debt ratio and a current ratio thereof and identify their positions, but this approach is not easy for general investors who lack accounting knowledge. In particular, for investors who are not familiar with the mathematical aspect, the difficulty of checking financial statements expressed only in numbers is bound to be further aggravated. In addition, because financial statements only show information for up to three years, individuals have limitations in determining long-term trends beyond that.

Meanwhile, existing securities service platforms provided by securities firms are also facing the same problems as described above. Basically, existing securities services are focused only on the convenience of trading and low fees, and investment-related information is also provided in a difficult and complex form centered on information providers, making it ineffective for new investors.

For example, the service platforms provide various financial indices such as an earnings per share (EPS) and a book-value per share (BPS) as analysis data, but these are specialized fields suitable for institutions or experts, and are not only easily accessible to general individual investors, but there are also limitations causing difficulty in identifying the extent to which the investment value of a company or asset is actually positioned through these indicators.

### DISCLOSURE OF INVENTION

### Technical Problem

The present disclosure is intended to solve the foregoing problems of the related art, and an aspect of the present disclosure is to provide a method and device of processing financial data of each company or asset including financial statements into a form optimized for training, performing an analysis on the value of each company or asset through machine learning utilizing the processed data, and performing an investment value evaluation service according to a user's need by using an analysis result.

However, a technical task to be achieved by this embodiment may not be limited to the above-described technical tasks, and other technical tasks may be present.

### Technical Solution

A device of providing an investment value evaluation service according to one embodiment of the present disclosure may include a preprocessing module that processes financial data for each company or asset collected from a market server to generate training data including figures for each preset financial indicator; an analysis module that is constructed through the training of a preset machine learning model using the training data to predict a value evaluation index for each company or asset, and output analysis data based on the predicted value evaluation index; and a service providing module that processes analysis data for a specific company or asset output from the analysis module according to an analysis request from a user terminal to provide investment value evaluation data to the user terminal, wherein the value evaluation index is a fair price representing an upside potential in the value of a company or asset according to the figures for each financial indicator compared to a current price.

According to one embodiment of the present disclosure, the preprocessing module may acquire figures for at least one financial indicator from among a price earning ratio (PER), a price-to-book ratio (PBR), a price selling ratio (PSR), a price cashflow ratio (PCR), an enterprise value compared to earnings before interest, tax, depreciation, and amortization (EV/EBITDA), a return on equity (ROE), a price earning growth ratio (PEGR), and depositary receipts (DR) for each company or asset through the financial data for each company or asset to set the acquired figures as training data.

According to one embodiment of the present disclosure, the preprocessing module may calculate an arithmetic and weighted average value of operating profit over a preset period for each company or asset through the financial data for each company or asset, and acquire a market sensitive indicator exhibiting a growth potential for each company or asset according to a market situation based on the calculated arithmetic and weighted average to set the market sensitive index as training data.

According to one embodiment of the present disclosure, the analysis module may identify the development tendencies of each company or asset according to the market sensitive indicator, identify a user's investment tendencies based on the previously collected user's financial transaction and investment history data, and then output user-customized analysis data based on the identified development tendencies and investment tendencies, wherein the user-customized analysis data is processed by the service providing module and provided to the user terminal.

According to one embodiment of the present disclosure, the preprocessing module may generate at least one of data on an item price, a supply and demand situation, and a wave analysis basic model for each company or asset through the financial data for each company or asset, and acquire price attractiveness indicating a relative strength of trading reflecting a price trend based on the generated data to set the acquired price attractiveness as training data.

According to one embodiment of the present disclosure, the analysis module may perform backtesting to analyze the user's investment performance through the previously collected user's investment history data, and select at least one or more items of companies or assets based on a result of the backtesting and the price attractiveness, and the service providing module may provide a user interface for automatic trading, including a function of setting a batch order and trading time condition for at least one of the items selected by the analysis module, to the user terminal.

According to one embodiment of the present disclosure, the analysis module may be designed to include at least one of an analysis algorithm of financial data including preset qualitative factors in the financial statements of each company or asset, an algorithm of analyzing a relative evaluation within the industry to which each company or asset belongs, an algorithm of analyzing the growth potential and stability of each company or asset compared to market capitalization, an algorithm of quantifying, smoothing, and compressing figures for the financial indicator of each company or asset, an analysis algorithm of semi-structured data in the financial data or the training data, and an algorithm of analyzing a relative strength of trading for each company or asset, through the training.

According to one embodiment of the present disclosure, the service providing module may generate an analysis report on the company or asset based on the analysis data to provide the generated analysis report to the user terminal, wherein the analysis report comprises an index flow chart reflecting a market situation, detailed diagnostic data on a value evaluation index, a polygonal graph showing figures for each financial indicator and a deviation from an industry average, and detailed diagnostic data on the figures for each financial indicator.

According to one embodiment of the present disclosure, the service providing module may provide a preset question for item filtering to the user terminal, automatically set search conditions according to an answer from the user terminal to the question to input the search conditions into the preprocessing module, and recommend at least one or more items of companies or assets satisfying the search conditions that are output from the analysis module to the user terminal for each preset cycle.

According to one embodiment of the present disclosure, there is provided a method of providing an investment value evaluation service using an investment value evaluation service providing device, and the method may include processing financial data for each company or asset collected from a market server to generate training data including figures for each preset financial indicator; performing the training of a preset machine learning model using the training data, predicting a value evaluation index for each company or asset on the basis of the training, and outputting analysis data based on the predicted value evaluation index; and processing analysis data for a specific company or asset output according to an analysis request from a user terminal to provide investment value evaluation data to the user terminal, wherein the value evaluation index is a fair price representing an upside potential in the value of a company or asset according to the figures for each financial indicator compared to a current price.

### Advantageous Effects

According to one embodiment of the present disclosure, financial data including financial statements, charts, markets and industries are analyzed from various perspectives and provided to a user.

According to one embodiment of the present disclosure, complex and massive financial data is converted into a simple indicator that is evaluated as the value of a company or financial asset and provided to a user.

According to one embodiment of the present disclosure, an intuitively understandable and readable analysis report is generated and provided to a user through training and processing of financial data.

According to one embodiment of the present disclosure, customized investment analysis data reflecting an individual's investment tendencies is provided to a user through training and processing of financial data.

According to one embodiment of the present disclosure, an automatic trading service for items with good trading strength is provided to a user through training and processing of financial data.

According to one embodiment of the present disclosure, search and filtering are performed through an interface that maximizes convenience, thereby periodically recommending items suitable for a user.

In this manner, in one embodiment of the present disclosure, difficult and complex financial and banking information is converted into easy-to-understand data and provided to a user, thereby also contributing to individual investors who make financial investments based on professional data and analysis.

Accordingly, investment losses of individual investors may be minimized and competitive investment strategies may be encouraged.

### BRIEF DESCRIPTION OF THE DRAWINGS

FIG. 1 is an architecture diagram of an investment value evaluation service providing system according to one embodiment of the present disclosure.

FIG. 2 is a block diagram showing a configuration of an investment value evaluation service providing device according to one embodiment of the present disclosure.

FIG. 3 is a conceptual diagram for explaining an operation process of an investment value evaluation service providing device according to one embodiment of the present disclosure.

FIG. 4 is an exemplary diagram of a user interface on which a value evaluation index according to one embodiment of the present disclosure is displayed.

FIG. 5 is an exemplary diagram of a user interface on which an analysis report according to one embodiment of the present disclosure is displayed.

FIG. 6 is an exemplary diagram of a user interface for explaining an item recommendation process according to one embodiment of the present disclosure.

FIG. 7 is an exemplary diagram of a user interface on which user-customized analysis data according to one embodiment of the present disclosure is displayed.

FIG. 8 is an exemplary diagram of a user interface for explaining an automatic trading process according to one embodiment of the present disclosure.

FIG. 9 is an exemplary diagram of a user interface for explaining an investment strategy-based trading simulation according to one embodiment of the present disclosure.

FIG. 10 is an operation flowchart of an investment value evaluation service providing method according to one embodiment of the present disclosure.

### BEST MODE FOR CARRYING OUT THE INVENTION

Hereinafter, embodiments of the present disclosure will be described in detail with reference to the accompanying drawings so as to be easily implemented by those skilled in the art. However, the present disclosure may be implemented in various different forms, and is not limited to the embodiments described herein. Furthermore, in order to clearly describe the present disclosure, parts not related to the description are omitted, and like reference numerals designate like parts throughout the specification.

Throughout the specification, in case where a portion is “connected” to the other portion, it may include a case of being “electrically connected” to the other portion by interposing an element therebetween as well as a case of being “directly connected” to the other portion. In addition, when a portion may “include” a certain element, unless specified otherwise, it may not be construed to exclude another element but may be construed to further include other elements.

In this specification, the term “unit” may refer to a unit implemented by hardware, software, and/or a combination thereof. Furthermore, one unit may be implemented by two or more pieces of hardware or two or more units may be implemented by one piece of hardware. Meanwhile, the term “portion” is not limited to software or hardware, and the term “portion” may also be configured to be in an addressable storage medium or may also be configured to operate one or more processors. Therefore, as an example, the term “unit” may include software elements, object-oriented software elements, elements such as class elements and task elements, processes, functions, attributes, procedures, subroutines, segments in program codes, drivers, firmware, microcodes, circuits, data, databases, data structures, tables, arrays, and variables. A function provided in elements and “units” may be combined into a smaller number of elements and “units” or sub-divided into additional elements and “units”. In addition, elements and “units” may also be implemented to operate one or more CPUs in a device or a secure multimedia card.

A “user terminal” referred to below may be implemented as a computer or portable terminal that may access a server or another terminal through a network. Here, the computer may include, for example, a notebook equipped with a web browser, a desktop, a laptop, a VR HMD (e.g., HTC Vive, Oculus Rift, GearVR, DayDream, PSVR, etc.), or the like. Here, the VR HMD includes a PC-based model (e.g., HTC Vive, Oculus Rift, FOVE, Deepon, etc.), a mobile-based model (e.g., GearVR, DayDream, Baofeng Mojing, Google Cardboard, etc.), and a standalone model implemented independently from a console-based model (PSVR) as a whole. A portable terminal is, for example, a wireless communication device that guarantees portability and mobility, and may include not only a smart phone, a tablet PC, a wearable device, but also various devices equipped with communication modules such as Bluetooth (Bluetooth low energy (BLE)), near field communication (NFC), radio frequency identification (RFID), ultrasonic, infrared, WiFi, LiFi, and the like. In addition, a “network” refers to a connection structure that allows information exchange between each node, such as terminals and servers, and includes a local area network (LAN), a wide area network (WAN), the Internet (WWW: World Wide Web), wired and wireless data communication networks, telephone networks, wired and wireless television communication networks, and the like. Wireless data communication networks include, for example, 3G, 4G, 5G, 3rd generation partnership project (3GPP), long term evolution (LTE), world interoperability for microwave access (WIMAX), Bluetooth communication, infrared communication, ultrasound communication, visible light communication (VLC), LiFi, and the like, but are not limited thereto.

Hereinafter, one embodiments of the present disclosure will be described in detail with reference to the accompanying drawings.

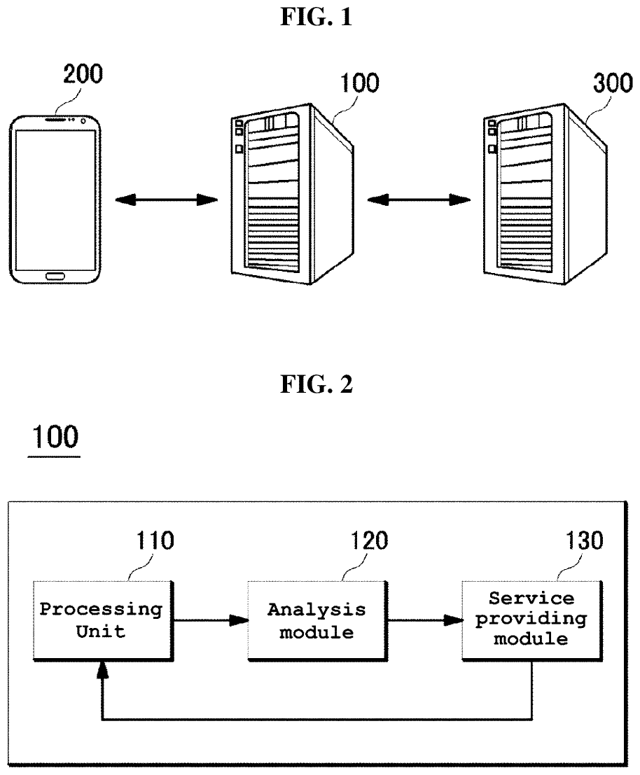

FIG. 1 is an architecture diagram of an investment value evaluation service providing system according to one embodiment of the present disclosure.

Referring to FIG. 1, a system according to one embodiment of the present disclosure may include an investment value evaluation service providing device 100, a user terminal 200, and a market server 300. Hereinafter, for the sake of convenience of explanation, the investment value evaluation service providing device 100 will be referred to as a “device.”

The market server 300 according to one embodiment may refer to an operating server of an institution that oversees investments in various financial assets such as stocks or cryptocurrencies. For example, it may be a server of an institution distributing a financial service platform, and the user terminal 200 may access the market server 300 to receive financial data or carry out an investment-related procedure, but this is publicly known information not directly related to the present disclosure, and thus a detailed description thereof will be omitted.

The user terminal 200 according to one embodiment refers to a terminal in which an investor is the main user of a trading service for various financial assets such as stocks or cryptocurrencies. Here, the investor is preferably an individual investor in consideration of the problems to be solved by the present disclosure, but is not limited thereto, and may include both institutional and foreign investors.

According to one embodiment, the user terminal 200 includes a memory (not shown), a processor (not shown), and a communication module (not shown), and the communication module performs data communication with the device 100 and the market server 300 under the control of the processor.

The memory stores a program (or application) for consuming an investment value evaluation service. In this case, the program (or application) may be provided to a user as a user interface received from the device 100 to implement the investment value evaluation service.

The processor executes a program stored in the memory and processes a series of operations to provide the investment value evaluation service to the user. As a representative example of an operation, the processor may request the device 100 to analyze a specific company or asset through the user interface, and accordingly, display investment value evaluation data received from the device 100 on the screen and provide the data to the user.

The device 100 according to one embodiment may refer to an operating device of a company that provides investment or other various financial services to the user terminal 200 in conjunction with the market server 300. The device 100 may be connected to the user terminal 200 and the market server 300 via a wired/wireless network, and may be provided with a communication module (not shown) for communicating with each other. Accordingly, the device 100 may provide a user interface for providing an investment value evaluation service to the user terminal 200, process various processes being performed through the user interface, and provide a result thereof to the user terminal 200. In addition, the device 100 may comprehensively collect financial data of each company or asset from the market server 300. Meanwhile, a form in which the device 100 is implemented is not particularly limited, but it is preferably implemented in the form of a cloud server for temporal and spatial flexibility.

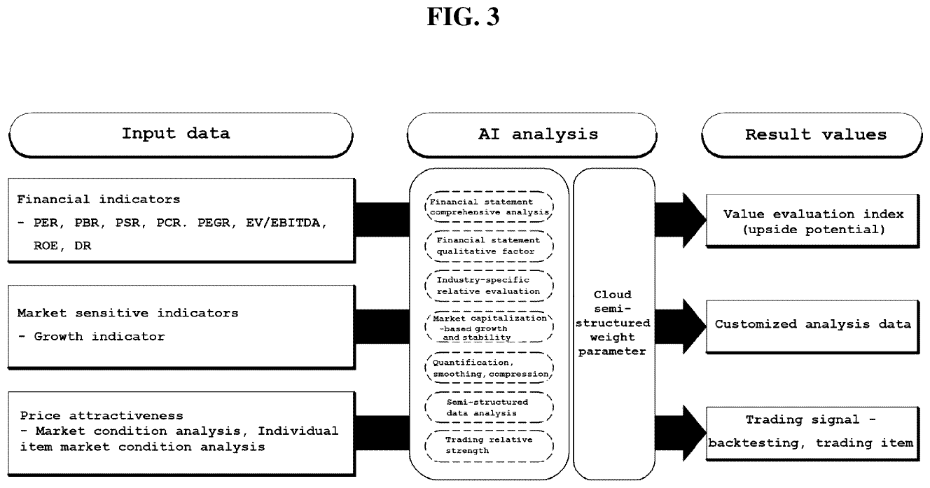

According to one embodiment, the device 100 may be divided into specific elements according to the process, and one embodiment for respective elements will be described with reference to FIGS. 2 and 3. FIG. 2 is a block diagram showing a configuration of an investment value evaluation service providing device according to one embodiment of the present disclosure.

Referring to FIG. 2, the device 100 may include a data management module (not shown), a preprocessing module 110, an analysis module 120, and a service providing module 130.

A data management module according to one embodiment may include a data lake API linkage unit and a database processing unit. The data lake API linkage unit collects financial data on each company or asset from a plurality of market servers 300 to construct a data lake that stores the data. Here, financial data, which is raw data that has not yet been processed, may include financial statements, charts, and data on markets and industries, but is not limited thereto. Meanwhile, the financial data may include not only structured data but also semi-structured data and unstructured data. The financial data stored in a data lake is used for analysis to derive a value evaluation index later, and an operation of extracting and storing various types of data generated in the process is performed by the database processing unit.

According to one embodiment, a preprocessing module 110 performs a preprocessing process of generating training data by processing financial data collected in advance from the market server 300 into a form that is optimized for training. That is, the preprocessing module 110 may extract feature values of non-standardized financial data and construct training data based on the extracted feature values.

In addition, the preprocessing module 110 extracts some of the stored financial data according to an analysis request from the user terminal 200 after the analysis module 120 is constructed through learning, and performs the role of preprocessing the extracted financial data into input data that is input to the analysis module. That is, the preprocessing module 110 may extract feature values of financial data for at least one company or asset searched by the user or filtered according to the user's intention, and generate input data based thereon.

Referring to FIG. 3, the preprocessing module 110 according to one embodiment may generate training data and input data including preset financial indicators, market sensitive indices, and price attractiveness.

According to one embodiment, the preprocessing module 110 may process the collected financial data to acquire figures for financial indicators that is preset for each company or asset and set the acquired figures as training data. Likewise, the preprocessing module 110 may process the extracted financial data according to the user's request after the analysis module 120 is constructed through training using training data to acquire figures for each financial indicator for a specific company or asset and set the acquired figures as input data.

According to one embodiment, the preprocessing module 110 may acquire figures for at least one financial indicator from among PER, PBR, PSR, PCR, EV/EBITDA, ROE, PEGR, and DR for a company or asset through financial data for a company or asset and set the acquired figures as training data.

The financial indicators listed above, which are indicators included in financial data that serve as criteria for evaluating the value of a company or asset and generating the resultant value evaluation index, are preset in the device 100, and the respective financial indicators will be described in brief below.

PER, which stands for price earning ratio, is an indicator of profitability of a stock price calculated by dividing the stock price by earnings per share.

PBR, which stands for price-to-book ratio, is a ratio that compares a stock price with a net asset value per share, that is, an indicator that measures how many times the stock price is traded per share compared to the net asset value.

PSR, which stands for price selling ratio, is calculated by dividing a stock price by sales per share, and refers to a growth potential investment indicator used to discover relatively undervalued stocks.

PCR, which stands for price cashflow ratio, is an indicator of a company's financial strength calculated by dividing a stock price by a cashflow per share.

EV, which stands for enterprise value, is a total value of a company including the company's ability to generate future profits, and EBITDA, which stands for earnings before interest, tax, depreciation and amortization, and refers to as a net profit before deducting interest expenses, taxes, depreciation expenses, and the like. Therefore, EV/EBITDA, which stands for enterprise value compared to earnings before interest, tax, depreciation and amortization, and refers to one of indicators for determining an appropriate stock price of a company.

ROE, which stands for return on equity, is one of indicators representing a company's profitability, and refers to an extent to which profits are generated for shares held by shareholders.

PEGR, which stands for price earning to growth ratio, is a value calculated by dividing PER by earnings per share (EPS), which is a current net income divided by a number of shares, and the lower the PEGR, the more likely it is that the stock price is undervalued compared to the company's growth potential.

DR, which stands for depositary receipts, is a stock depository certificate that allows a foreign depository institution to issue and distribute securities when the company issues stocks overseas, not in the market where it is listed, and refers to an indicator utilized to determine an appropriate stock price in consideration of a foreign market.

According to one embodiment, the preprocessing module 100 may track raw data for each indicator, such as EPS, BPS, SPS, CFPS, EVEBITDAPS, EPSGR, ROE, DR, stock prices, a number of floating stocks, assets, liabilities, cashflow, sales, and operating profit in financial data, and based thereon, acquire training data including at least one of PER, PBR, PSR, PCR, EV/EBITDA, ROE, PEGR, and DR.

According to one embodiment, the preprocessing module 110 may calculate a market sensitive indicator that is preset as a growth indicator to supplement the accuracy of a result of analysis reflecting a market situation with respect to the figures of the financial indicator and the resultant value evaluation. That is, the preprocessing module 110 may process the collected financial data to acquire a market sensitive indicator for each company or asset and set the acquired indicator as training data. Likewise, the preprocessing module 110 may process the extracted financial data according to the user's request after the analysis module 120 is constructed through training using training data to acquire market sensitive indicators for a specific company or asset and set the acquired figures as input data. These market sensitive indicators may be utilized as data to identify the development tendencies of a company or asset and the investment tendencies of a user through the analysis module 120 later.

According to one embodiment, the preprocessing module 110 may extract and process at least one of earnings before interest and tax (EBIT), ROE, CF data, respective industry averages thereof, stock prices, return on equity (ROE), cashflow data (CF), industry average data, and stock price data over a preset period for each company or asset from financial data, and calculate an arithmetic and weighted average value of EBIT for each company or asset, and acquire a market sensitive indicator based on the calculated arithmetic and weighted average value.

According to one embodiment, the preprocessing module 110 may acquire a graph-based price attractiveness that indicates a relative strength for trading in response to the figures of the financial indicator and the resultant value evaluation. To this end, the preprocessing module 110 may analyze market conditions for each market through financial data, and analyze the market conditions for individual items. Here, the price attractiveness, which is a relative trading strength that is utilized as an indicator for determining a quant investment-based trading strategy, may be defined as vacuum, which is a force that attracts trading.

That is, the preprocessing module 110 may process the collected financial data to acquire price attractiveness for each company or asset and set the acquired price attractiveness as training data. Likewise, the preprocessing module 110 may process the extracted financial data according to the user's request after the analysis module 120 is constructed through training using training data to acquire price attractiveness for a specific company or asset and set the acquired figures as input data.

According to one embodiment, the preprocessing module 110 may extract at least one of data of an item price, a supply and demand situation, and a wave analysis basic model for each company or asset through the collected financial data, and process the extracted data to acquire price attractiveness modeled based on the wave of the graph.

According to one embodiment, the device 100 may repeat training through a preset machine learning model using training data generated by the preprocessing module 110, thereby constructing the analysis module 120 that outputs analysis data including a value evaluation index for each company or asset. Here, the value evaluation index, which exhibits an upside potential of the value of a company or asset according to figures for each financial indicator, may be expressed as a fair price that indicates the extent to which a value compared to a current price of an item is evaluated (overvalued or undervalued).

In one embodiment, the type of a machine learning model such as CNN or DNN is not limited, but a temporal pattern attention technology optimized to predict an appropriate stock price of an individual company may be applicable by getting out of the existing four fundamental arithmetic operations. Additionally, machine learning models may be applicable with a sequential ensemble approach technology to optimize risk management models for individual portfolios.

According to one embodiment, a training algorithm applied to the machine learning model may include multiple linear regression, market cap horizontalization, relative evaluation (for a stock price or value), and convergence optimization (for a stock price or value) algorithms, but is not limited thereto, and various analysis algorithms of the analysis module 120 may be designed and optimized through the repetition of training on the basis of the above training algorithms.

The analysis module 120 receives input data on at least one or more companies or assets generated according to an analysis request from the user terminal 200 via the user interface from the preprocessing module 110, processes an analysis algorithm constructed through training to output analysis data, and transmits the output analysis data to the service providing module 300. In addition, the analysis module 120 may continuously update the analysis algorithm by performing training through the output analysis data.

Referring to FIG. 3, the analysis module 120 according to one embodiment may be divided into specific elements according to an analysis algorithm being processed, and the elements may include a financial statement comprehensive analysis unit, a financial statement qualitative factor analysis unit, an industry-specific relative evaluation analysis unit, a market capitalization-based growth and stability analysis unit, a quantification/smoothing/compression processing unit, a semi-structured data analysis unit, and a trading relative strength analysis unit.

That is, as described above, through machine learning using training data, various analysis algorithms for input data may be designed in the analysis module 120. Specifically, at least one of a diversified analysis algorithm of financial data including preset qualitative factors in the financial statements of each company or asset, an algorithm of analyzing a relative evaluation of an item within the industry to which each company or asset belongs, an algorithm of analyzing the growth potential and stability for each company or asset compared to market capitalization, an algorithm of quantifying, smoothing, and compressing figures for a financial indicator of each company or asset, an algorithm of analyzing semi-structured data in financial data or training data, and an algorithm of analyzing a relative strength of trading for each company or asset may be designed in the analysis module 120.

Through this, the analysis module 120 may perform a process of optimizing the most suitable industry-specific weight parameter values that reflect market price trends, and may index a financial indicator that has the greatest influence on the convergence of an appropriate stock price for each item.

According to one embodiment, the analysis module 120 may identify the development tendencies of a company or asset through market sensitive indicators that are input from the preprocessing module 110. Additionally, the analysis module 120 may identify the user's investment tendencies based on the user's financial transaction and investment history data previously collected through the user interface. The analysis module 120 may output user-customized analysis data including a value evaluation index of at least one company or asset according to the identified development tendencies and investment tendencies.

In addition, the analysis module 120 may perform relationship training among the figures of financial indicators, market sensitive indicators and price attractiveness for each company or asset, and when the training is completed and then input data is entered, a user-customized price evaluation index, a market sensitive indicator and price attractiveness may be accurately acquired.

According to one embodiment, the analysis module 120 may perform backtesting through previously collected user investment history data to analyze the performance of investments made for a preset period in the past. The analysis module 120 may select and output at least one or more items of companies or assets based on a result of the backtesting and the price attractiveness that is input from the preprocessing module 110. The items selected in this manner, which are determined to be items of interest to the user, may be recommended to the user as targets of an automatic trading service.

The service providing module 130 according to one embodiment provides an investment value evaluation service to a user by transmitting a user interface to the user terminal 200, and performs a role of processing various processes being performed through the user interface. That is, the service providing module 130 transmits an analysis request from the user terminal 200 through a user interface to the preprocessing module 110, and accordingly receives analysis data output from the analysis module 120, processes the received data into a preset format to displays the processed data on the user interface.

According to one embodiment, the service providing module 130 may input a company or asset specified by the user terminal 200 into the preprocessing module 110. The preprocessing module 110 may process the financial data of the company or asset to generate input data and input the generated data into the analysis module 120, and the service providing module 130 may extract data corresponding to an analysis request from the user terminal 200 from among the analysis data for the company or asset that is output by the analysis module 120 and display the extracted data on the user interface. In addition, the service providing module 130 may input search conditions entered by the user terminal 200 into the preprocessing module 110. The preprocessing module 110 performs filtering according to search conditions to extract financial data that satisfies the search conditions from among the stored financial data, and inputs input data preprocessed with the extracted data into the analysis module 120. The service providing module 130 may process data corresponding to an analysis request from the user terminal 200 from among the analysis data that is output by the analysis module 120 and display the processed data on the user interface.

According to one embodiment, the service providing module 130 may process analysis data that is output from the analysis module 120 to generate an analysis report including a value evaluation index and display the generated report on the user interface.

According to one embodiment, the service providing module 130 may process user-customized analysis data that is output from the analysis module 120 into a preset format to display the processed data on a user interface.

According to one embodiment, the service providing module 130 may provide an automatic trading service to the user terminal 200. Specifically, the service providing module 130 may display a result of backtesting performed by the analysis module 120 on the user interface, and list items selected by the analysis module 120 according to the result of the backtesting and price attractiveness to display them on the user interface. The service providing module 130 may receive and process a batch order request for at least one of the items organized in the list from the user terminal 200, and perform a selling (and selling) process for the item at the time of trading according to the user's input for preset trading conditions.

According to one embodiment, the service providing module 130 may provide an interactive item recommendation service to the user terminal 200 to facilitate the convenience of individual investors who are not familiar with item screening. Specifically, the service providing module 130 may display a preset question for item filtering on the user interface. The service providing module 130 may receive an answer to the question from the user terminal 200 and automatically set search conditions based on the answer and input them into the preprocessing module 110. The service providing module 130 may list at least one or more items of companies or assets satisfying the search conditions that are output from the analysis module 120 and analysis data therefor and display them on the user interface. In addition, the service providing module 130 may update the list for each preset cycle and provide the updated list to the user terminal 200, and accordingly, optimal items may be recommended to the user for each cycle.

Meanwhile, global capital flows are continuous, and sector flows exist by country. (e.g., Japanese chemicals→American chemicals→Taiwanese chemicals, etc.) However, with conventional technology, there is a problem in that it is difficult to identify investment opportunities simply by price trends, institutions that invest by analyzing macro information are poor, and substitutes are limited at the level of automation.

In order to resolve this situation, the service providing module 130 according to one embodiment may provide a macro financial data analysis solution through calculating an appropriate value of a preset country-specific industrial sector and tracking an upside potential convergence indicator by utilizing a preset quant investment algorithm. This is a starting point of the process of finding an indicator that is distinct from a simple price, and an analysis solution may be automatically constructed by finding an accurate indicator on the basis of the machine learning technology of the analysis module 120. That is, there is always a motive for investment, and there are large funds that obtain the motive and move first, and when investment begins, institutional investment follows, so it is possible to track movement to identify when the industry is changing from undervalued to overvalued, and the device 100 may construct a tracking service that finds an indicator close to the cause and provide it to the user terminal 200.

Through this, the device 100 may provide various analysis service information in conjunction with subscription services of analysts who have entered the global investment market, direct investment services, or planning and sales services for investment products.

For example, when a sector in a specific country grows, funds often flow into promising companies or large companies in the sector, so the device 100 may obtain an upside potential of the sector by country and identify the movement of price and value based on a slope of the upside potential. Furthermore, the device 100 may find an indicator causing the slope of the upside potential through the analysis module 120. Accordingly, the user may clearly predict when large funds have started to move, thereby promoting the effect of establishing investment balances and strategies at that time.

As a specific example, the device 100 may predict, through AI analysis, that funds will begin to flow into the chemical sector in Japan and that investments will flow into strong companies, based on the growth of PER and ROE, and provide data on companies or assets that have just begun to receive funds to the user terminal 200 by utilizing a model of such patterned data.

In order to implement this, the device 100 may acquire, through the preprocessing module 110, an average value of each country's financial indicators by sector and figures for each financial indicator of representative companies in the sector (up to 60% or more of the total market capitalization). Then, the device 100 may calculate a price evaluation index to compute an upside potential, and monitor a movement in which the upside potential converges to an appropriate stock price. In addition, the analysis module 120 may perform a process of optimizing industry-specific weight parameter values that reflect price trends on the basis of machine learning, and may index a value indicator that has the greatest influence on the convergence of an appropriate stock price.

Hereinafter, more specific embodiments of an operation method of the device 100, which leads to the preprocessing, analysis, and service providing processes of input data will be described with reference to FIG. 3.

As a first embodiment, the device 100 preprocesses the financial data of an item according to a user's analysis request into figures for each financial indicator, then performs AI analysis using the preprocessed data as input data to predict a value evaluation index, and derives analysis data based thereon. The device 100 processes analysis data into a format according to the user's intention to generate investment value evaluation data and provides the generated data to the user terminal 200.

Meanwhile, financial indicators may include, as mentioned above, PER (price earning ratio), PBR (price-to-book ratio), PSR (price selling ratio), PCR (price cashflow ratio), EV/EBITDA (enterprise value compared to earnings before interest, tax, depreciation, and amortization), ROE (return on equity), PEGR (price earning to growth ratio), and DR (depositary receipts).

A specific process of predicting, by the device 100, a value evaluation index is as follows.

As of stage 1, the device 100 extracts or classifies financial data on items of companies or assets selected or extracted for analysis from among financial data stored in a data lake through a database processing unit. The preprocessing module 110 processes the extracted or classified financial data to acquire figures for each financial indicator for the item. For example, when the item belongs to a plurality of industrial sectors, the preprocessing module 110 acquires the figures of a financial indicator for each sector and calculates an average value of each financial indicator for each sector.

As of stage 2, the device 100 inputs figures for each financial indicator output from the preprocessing module 110 into the analysis module 120. The financial statement comprehensive analysis unit and the financial statement qualitative factor analysis unit may analyze the flow of figures that change in real time for each financial index and the trend of financial indicators using financial data. In addition, based on a result of the analysis, the industry-specific relative evaluation analysis unit may calculate a relative value (raw value) for each financial indicator. Here, the relative value may be defined as a figure that indicates how different each financial indicator is from an average within the industry to which the item belongs. Meanwhile, when semi-structured data within financial data or financial indicators is used in an analysis process, it may involve a process of converting semi-structured data into structured data by the data analysis unit.

As of stage 3, the industry-specific relative evaluation analysis unit determines whether a relative value for each financial indicator of the item is positive or negative. The relative value determined to be negative is converted to a positive value using a method such as a squaring process by the quantification processing unit. In this manner, all the quantified relative values are input to the compression/smoothing processing unit to remove noise and correct errors.

As of stage 4, the analysis module 120 derives a final evaluation value (appropriate value) for each financial indicator based on a relative value for each financial indicator that has been quantified/compressed/smoothed using a stock price convergence optimization algorithm. The analysis module 120 assigns a weight to each derived appropriate value according to an importance factor that is preset for each financial indicator. Then, the analysis module 120 calculates a final appropriate value by synthesizing appropriate values for respective weighted financial indicators and sets the calculated value as a value evaluation index. In addition, the value evaluation index is applied to a current price to determine whether the item is overvalued or undervalued.

Through this process, the value and current status of an item, which may be known through complex and massive financial data, are calculated as a simplified figure called a value evaluation index. Accordingly, individual investors who are ignorant of accounting or finance may easily establish quant-based investment strategies on the basis of professional knowledge rather than relying on intuition and rumors.

In addition, the device 100 performs a cloud-based machine learning analysis, and may efficiently, automatically, and quickly produce and provide financial statement evaluation reports (analysis reports) of approximately 10,000 listed companies in the U.S., Korea, and the like, wherein the value evaluation index has an advantage of allowing a relative evaluation of the values of all listed companies around the world according to international accounting standards.

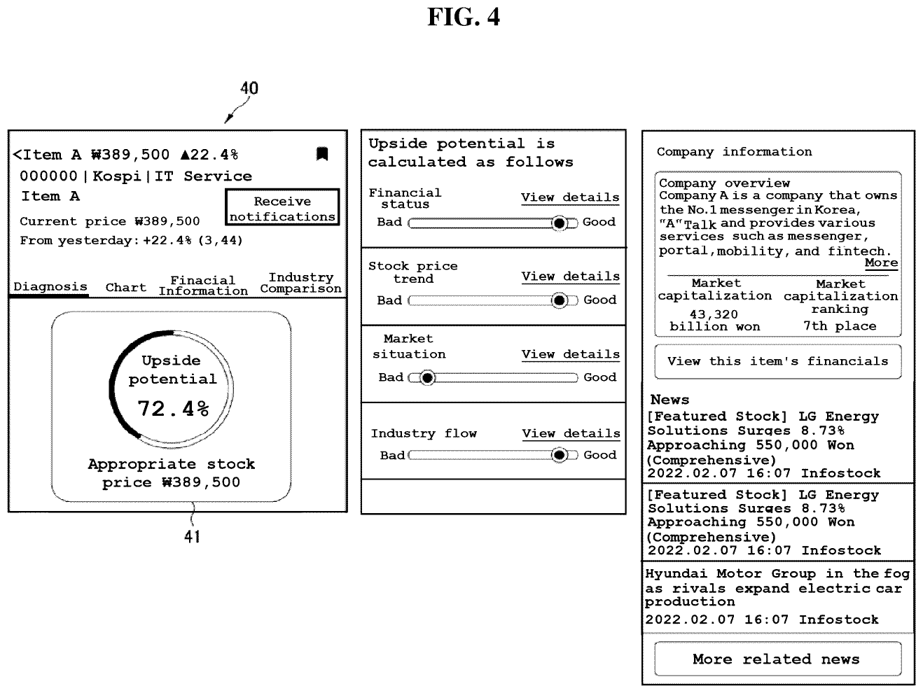

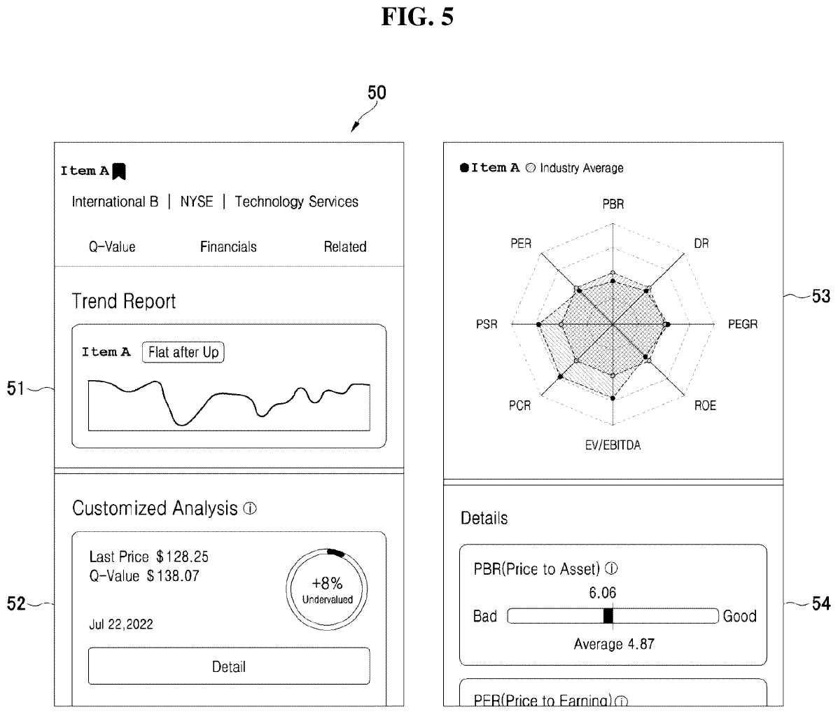

FIG. 4 shows an example of a user interface 40 displaying investment value evaluation data. Referring to FIG. 4, the device 100 may analyze item A selected by the user, derive a value evaluation index 41 predicted as a fair price of item A, and display the derived index on the user interface 40. In addition, the device 100 may determine the value evaluation index 41 by comparing it with a current price of item A and calculate an upside potential percentage according to a result of the determination and additionally display it on the user interface 40. In addition, the device 100 may display specific analysis data of the value evaluation index (fair price) of item A according to machine learning on the user interface 40. As shown in FIG. 4, specific analysis data may include analysis data on the financial status, stock price trend, market situation, and industry trend of the item, but is not limited thereto. In addition, as shown in FIG. 5, the device 100 may display part or all of the overview and financial data of a company or asset corresponding to item A on the user interface 40, and additionally retrieve news related to the item and display the retrieved news on the user interface 40.

FIG. 5 shows an example of a state in which investment value evaluation data is processed into an analysis report 50 and displayed on a user interface. Referring to FIG. 5, the analysis report 50 may include an index flow chart area 51. A chart provided herein may be generated to reflect a market situation, and the device 100 may generate the description data of the chart to additionally display the generated description data in the area 51 or in a sub-area according to a click on the area 51. In this case, the description data may include data that displays sections showing rising and falling signals within the chart by distinguishing them with preset visual effects, data that displays the ratios and periods of rising and falling signals, and text data that describes the diagnosis of a market situation and price trend for a preset period (short-term, medium-term, long-term), but is not limited thereto. Accordingly, the complex problems of charts for experts provided by conventional financial institutions or the problems of charts for individual investors that are too simple and lack informativeness may be solved.

Furthermore, the analysis report 50 may include a value evaluation index display area 52. In the area 52, the value evaluation index and closing price (current price) of an item selected by a user may be displayed, and data on how an upside potential and an actual value compared therewith are evaluated may be displayed. In addition, the analysis report 50 may include a financial indicator display area 53. In the financial indicator display area 53, a polygonal graph in which each financial indicator is made up of vertices may be displayed, and accordingly, figures for each financial indicator of the item and industry average figures may be visually expressed. Accordingly, visibility for users may be secured, and indicator figures for the item and industry averages may be visually compared to facilitate immediate understanding for users. Furthermore, the analysis report 50 may include a specific financial indicator diagnosis area 54, thereby allowing the user to easily identify the extent to which figures for each financial indicator are positioned compared to the industry averages.

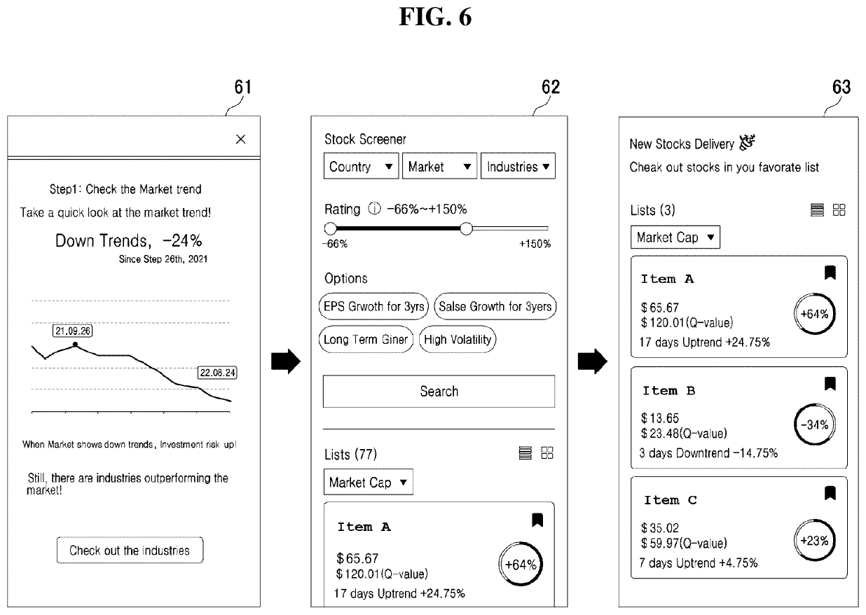

FIG. 6 shows an example of a user interface for an item recommendation based on investment value evaluation. First, the device 100 provides a user interface 61 on which preset questions for item filtering are displayed. When an answer to the question is received by the user terminal 200, the device 100 performs screening based on the answer to automatically set search conditions, and switches to a user interface 62 displaying the same. The user may immediately check the search conditions through the user interface 62, and if an adjustment is desired, adjust field values for at least one or more search conditions. When the search conditions are confirmed, the device 100 may extract financial data according to the search conditions, process the extracted data to generate input data, and derive analysis data through AI analysis. The device 100 may provide a user interface 63 that displays a list of items analyzed as satisfying the search conditions and analysis data thereof to the user terminal 200. In addition, the device 100 may periodically perform an analysis according to search conditions, update the list for each cycle, and provide a user interface 63 that displays the updated list to the user terminal 200.

Referring again to FIG. 3, as a second embodiment, the device 100 generates a market sensitive indicator, which is an adjustment value reflecting a market situation in response to a value evaluation index. As described above, the device 100 may calculate an arithmetic and weighted average value of operating profit over a preset period for each company or asset through financial data for each company or asset, and acquire a market sensitive indicator according to a market situation based on the calculated arithmetic and weighted average. Then, the device 100 performs AI analysis using the market sensitive indicator as input data to derive user-customized analysis data, processes the data into a preset format, and provides the processed data to the user terminal 200.

A specific process of acquiring, by the device 100, a market sensitive indicator and deriving analysis data therethrough is as follows.

As of stage 1, the device 100 extracts or classifies financial data on items of companies or assets selected or extracted for analysis from among financial data stored in a data lake through a database processing unit. The device 100 processes extracted or classified financial data to acquire the operating profit of the company or asset for a preset period, and adds them up to calculate an arithmetic average value.

As of stage 2, the device 100 converts an arithmetic average value of operating profit, if it is negative, into a positive value, and performs a compression and smoothing process on an arithmetic average value converted into a positive value or an arithmetic average value that is a positive value to remove noise and correct an error.

As of stage 3, the device 100 determines an importance factor for each operating profit over a preset period. The device 100 assigns a weight to each operating profit according to the importance factor, and then calculates a weighted average value for the operating profit to which the weight is applied.

As of stage 4, the device 100 adjusts at least one or more financial indicators based on arithmetic and weighted values for operating profit over a preset period to acquire at least one or more market sensitive indicators exhibiting a growth potential of the company or asset according to a market situation. For example, the device 100 may track a correlation between stock price fluctuations for financial indicators such as an operating profit growth rate, a revenue growth rate, and a cashflow growth rate of the company or asset, and adjust respective financial indicators based thereon to calculate a market sensitive indicator.

As of stage 5, the acquired market sensitive indicator may be input to the analysis module 120, and analyzed through the market capitalization-based growth and stability analysis unit. For example, the market sensitive indicator may be classified into 7 stages according to a figure range, and the market capitalization-based growth and stability analysis unit may identify which stage the calculated market sensitive indicator is classified into, and identify the development tendencies of companies or assets that match the identified stage. The development tendency matching each stage may be set as follows.
Stage 1—Stability type
Stage 2—Stability-seeking type
Stage 3—Stability growth type
Stage 4—Risk neutral type
Stage 5—Growth stability type
Stage 6—Growth-seeking type
Stage 7—Growth focus type

In addition, the analysis module 120 may adjust a value evaluation index of the company or asset by applying a preset rate according to the identified development tendency. (For example, when the market sensitive indicator is classified as stage 1, the existing value evaluation index is adjusted by approximately 15%, and when it is classified as stage 7, the existing value evaluation index is adjusted by 95%.)

In this way, the device 100 may identify the development tendency of a company through AI analysis of the calculated market sensitive indicator and adjust the resultant value of the company. The device 100 may derive customized analysis data by applying the user's investment tendencies identified based on the user's financial transaction and investment history data. In addition, the device 100 may process customized analysis data into a customized analysis report to provide the processed report to the user terminal 200. For example, in the case of a stability type in stage 1, a customized analysis report may be generated based on an analysis result on the basis of financial statements such as assets and liabilities, and in the case of a growth focus type in stage 7, it may be generated based on an analysis result on the basis of an income statement.

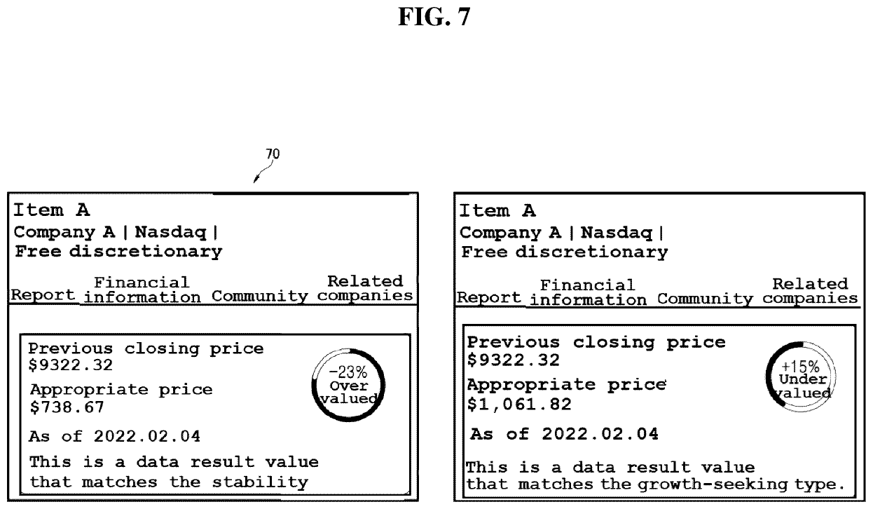

FIG. 7 shows an example of a user interface 70 displaying customized analysis data. A left side of FIG. 7 is analysis data on an investment tendency close to a stability type, and a right side thereof is analysis data on an investment tendency close to a growth type. By comparing these, it can be seen that even for the same stocks with the same closing price of the previous day, the existing value evaluation index is adjusted according to the market sensitive indicator, so the value of the item is evaluated differently. Accordingly, a user may establish an optimal investment strategy through value evaluation customized for his or her investment tendencies.

Referring again to FIG. 3, as a third embodiment, the device 100 may generate at least one of data of an item price, a supply and demand situation, and a wave analysis basic model for each company or asset through the collected financial data, and acquire price attractiveness indicating a relative strength of trading reflecting a (stock) price trend based on the generated data. The device 100 may perform AI analysis using price attractiveness as input data to output a trading signal based on value evaluation, and on the basis thereof, provide various trading services including automatic trading to the user terminal 200. That is, the device 100 may track a value of power that an arbitrary item has and a certain wave generated according to the power, and when it is confirmed that the wave shows a certain periodicity, it may be selected as a trading item. The device 100 may provide a trading service including an entire process of trading for the item to the user through a user interface.

A specific process of the third embodiment performed by the device 100 is as follows.

As of stage 1, items of companies or assets selected by the user terminal 200 or matching the search conditions of the user terminal and the financial data of the items are extracted.

As of stage 2, data on a price (index), a supply and demand situation, and an (index) wave analysis basic model of the market to which the items belong is generated through the extracted financial data, and a relative strength of the market is calculated based thereon. Here, the relative strength may refer to a strength of price and trading trend expressed in a figure (percentage) by analyzing rising and falling section within price fluctuations for a preset period. For example, when the relative strength is below 30%, it may be determined as an oversold section, and when the relative strength is over 70%, it may be determined as an overbought section.

As of stage 3, data on a price (stock price), a supply and demand situation, and a (stock price) wave analysis basic model is generated for each item through the extracted financial data, and a relative strength for each individual item is calculated based thereon.

As of stage 4, a relative strength for each item is determined by comparing it with a relative strength of the market, and a value evaluation index for each item is predicted. Based on a result of the comparison between the relative strength and the value evaluation index, an adjustment value for the relative strength is calculated for each item, and price attractiveness for each item is acquired by applying the adjustment value. Meanwhile, a specific process of predicting a value evaluation index will be replaced with the foregoing description in the first embodiment.

As of stage 5, the modeling of price attractiveness is performed for each item to process each price attractiveness into a preset visual model. The visual model is typically illustrated as a chart, but is not limited thereto.

As of stage 6, noise within each price attractiveness model is removed and the shape and form are optimized through the trading relative strength analysis unit and the semi-structured data analysis unit.

As of stage 7, each price attractiveness model is used to track a wave that represents a price trend for each item. For example, a degree of price dispersion is tracked for each item over a preset period through the trading relative strength analysis unit and the semi-structured data analysis unit.

As of stage 8, items that are advantageous for entry (e.g., buying) or liquidation (selling) are determined according to a result of the wave tracking. In addition, an update process of optimizing a logic of an analysis algorithm including the trading relative strength analysis unit is performed according to the result of the wave tracking.

As of stage 9, a buy/sell (entry or liquidation) signal for the item determined in stage 8 is generated and provided to a user through a user interface.

In this manner, price attractiveness may be analyzed by AI and utilized in a trading signal providing service. For example, the trading signal providing service may be implemented in the form of an investment advisory subscription model service within an asset management company's institutional fund management or investment service, but is not limited thereto. In particular, the trading signal providing service may be implemented as an automatic trading service through a user interface, and a specific example thereof will be described below.

Meanwhile, as another embodiment related to the third embodiment, the device 100 may generate a market condition analysis report including a market condition analysis and an individual stock price analysis based on price attractiveness and provide the generated report to the user terminal 200. Here, the market condition analysis report, which is for quant investment, may be one of the analysis reports as described above in the first embodiment.

Specifically, the device 100 generates price trend data indicating fluctuations in prices (indices and individual stock prices) and the resultant trends based on market relative strength and price attractiveness for each item. That is, the price trend data is data that shows the flow of market indices and stock prices of individual items over time, and the device 100 identifies whether each point is a rising or falling point by comparing it with the preceding and following points in time. In addition, the device 100 tracks the inflection points of rising and falling through the identified rising and falling points, and divides the price trend data into a plurality of sections based thereon. At this time, the respective divided sections may be classified into five categories according to the price trend, and for example, the respective categories may be set as rising, falling, stagnant while rising, and stagnant while falling.

The device 100 may input the processed price trend data into the analysis module 120 to perform AI analysis so as to derive market condition analysis data including a chart, and the service providing module 130 may process the data in the form of a market condition analysis report to provide the processed report to the user terminal 200.

In addition to the market condition analysis report according to one embodiment, using the golden cross and dead cross of the short-term and long-term moving averages for a certain period of time to diagnose whether the current situation is ‘rising’ or ‘falling’ may be a most common method, and the price attractiveness according to one embodiment may also be acquired by starting with the above method.

The device 100 may analyze past financial data to track preset parameter values in order to find inflection points of periods when there were changes of a scale that could be felt as a tectonic shift in the market, and among them, weights may be assigned to most recent parameter values that differ from the current time by a preset period.

Meanwhile, the most difficult part to identify is a definition of ‘stagnant’, which is a transitional stage of the market, and there may be no set standard, but according to one embodiment, the device 100 may determine a stagnant time point as a point in time when a standard deviation of supply and demand and price information decreases to a preset size or more.

In addition, the device 100 performs optimization work by utilizing past financial data to calculate parameter values with a preset size. For example, the device 100 may determine that a rising signal that may be linked to profit realization has been produced at a point in time when there is a high probability that a rising trend will continue for about 20 to 500 trading days or more subsequent to the generation of the rising signal.

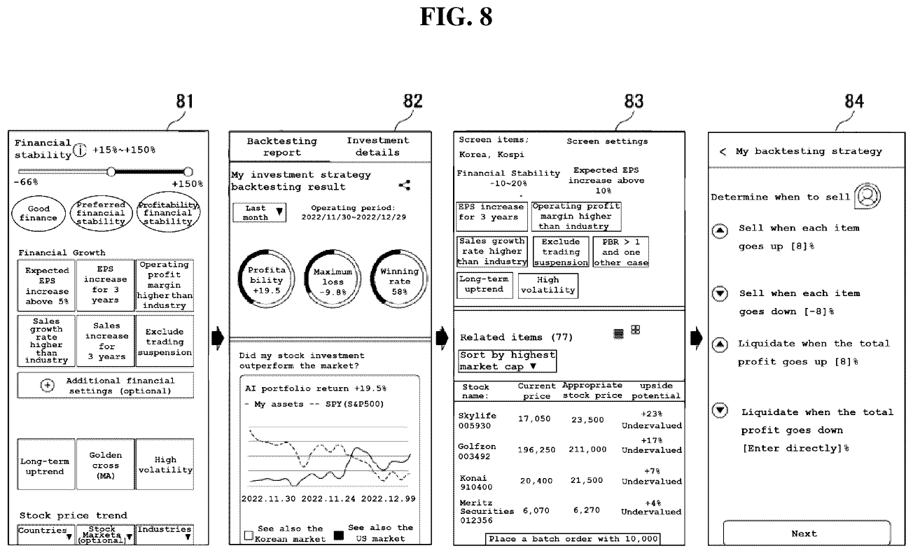

FIG. 8 shows an example of a user interface that implements an automated trading service using price attractiveness. Referring to FIG. 8, the device 100 provides a user interface 81 including a field value input function for preset search conditions to the user terminal 200. When a field value input is completed by the user terminal 200, the device 100 may extract financial data for at least one item corresponding to the input field value. The device 100 preprocesses the extracted financial data to derive a value evaluation index and price attractiveness of the items. Then, the device 100 performs backtesting using the user's investment history data and provides a user interface 82 displaying a result thereof to the user terminal 200. The device 100 performs AI analysis using a result of the backtesting and price attractiveness to output a trading signal, and selects at least one or more items as an investment entry item according to the trading signal. The device 100 organizes the selected items into a list and provides a user interface 83 displaying the list to the user terminal 200. A user may select at least one or more items from among the items organized in the list and place a batch order, and the device 100 may process the order in conjunction with the market server 300. In addition, the device 100 may provide a user interface 84 displaying preset trading conditions to the user terminal 200 and receive setting values of each condition from the user terminal 200. Then, when it is determined that at least one condition has been met, the device 100 may process the trading of an item corresponding thereto in conjunction with the market server 300.

According to one embodiment, the device 100 may provide a wider range of services to the user through the user interface, in addition to the examples of the user interface introduced through the first to third embodiments. For example, the user interface may include a portfolio diagnosis interface, a performance report interface, a risk-to-return detailed report interface, a holding portfolio optimization and rebalancing interface, a quant analysis service interface, an operation report interface, a trading simulation interface, and the like.

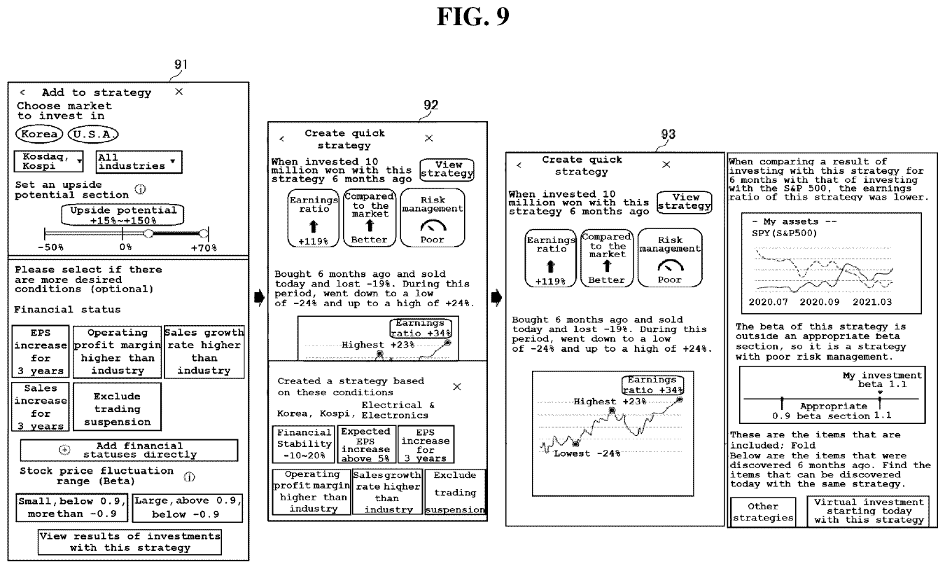

FIG. 9 shows an example of a trading simulation interface on the basis of investment strategy generation. Referring to FIG. 9, the device 100 provides a user interface 91 including a field value input function for at least one of preset investment strategy conditions to the user terminal 200. When the input of field values for investment strategy conditions including a market, an industry, and an upside potential section to be invested in by the user terminal 200 is completed, the device 100 determines the investment strategy conditions according to the input field values and provides a user interface 92 displaying the investment strategy conditions to the user terminal 200. In addition, the device 100 extracts financial data for at least one company or asset corresponding to the determined investment strategy conditions. The device 100 may preprocess the extracted financial data and then input the preprocessed data into the analysis module 120 to generate at least one investment strategy according to the determined investment strategy conditions. In addition, the device 100 may perform an investment analysis to which the investment strategy is applied prior to a preset period (6 months in the drawing as an example) through the analysis module 120, and provide a user interface 93 displaying a result thereof to the user terminal 200. As shown in FIG. 9, the result of the investment analysis may include, for example, an earnings ratio analysis for the period according to the strategy, an investment evaluation analysis of the strategy compared to a market according to the earnings ratio, and a risk management capability analysis of the strategy, but is not limited thereto. Then, in response to a request for a trading simulation (virtual investment) according to the strategy of the user terminal 200, the device 100 may select at least one company or asset item that matches the strategy as of the current date and perform a trading simulation based on financial data thereon, and provide a result thereof to the user terminal 200 in real time. On the contrary, when a request for another strategy is received from the user terminal 200, the device 100 provides the user interface 91 including a field value input function for investment strategy conditions to the user terminal 200 again.

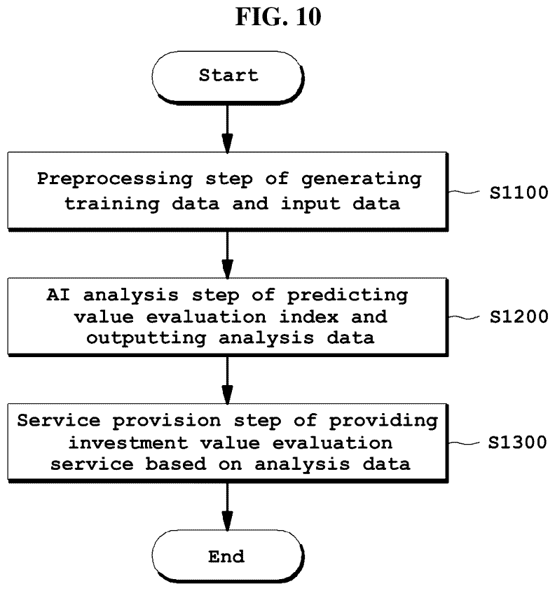

Hereinafter, a method of providing an investment value evaluation service of the present disclosure will be described in brief with reference to FIG. 10. FIG. 10 is an operation flowchart of an investment value evaluation service providing method according to one embodiment of the present disclosure, and specific examples of each process are replaced with the foregoing description.

In step S1100, the device 100 performs a preprocessing process of processing financial data for each company or asset collected from the market server 300 to generate training data including figures for each preset financial indicator.

In step S1200, the device 100 constructs an analysis module 120 by performing the training of a preset machine learning model using training data, and performs AI analysis process of predicting a value evaluation index for each company or asset through the analysis module 120 and outputting analysis data based on the predicted value evaluation index.

In step S1300, a service provision process of generating input data according to an analysis request from the user terminal 200, processing analysis data for a specific company or asset output through AI analysis of the generated input data, and providing investment value evaluation data to the user terminal 200 is performed.

Although the method and system of the present disclosure have been described with respect to specific embodiments, some or all of elements or operations thereof may be implemented using a computer system having a general-purpose hardware architecture.

The foregoing description of the present disclosure is for illustrative purposes, but it will be apparent to those skilled in the art to which the present disclosure pertains that the present disclosure can be easily modified in other specific forms without departing from the technical concept and essential characteristics thereof. Therefore, it should be understood that embodiments described above are merely illustrative but not restrictive in all aspects. For example, each element described as a single entity may be distributed and implemented, and likewise, elements described as being distributed may also be implemented in a combined manner.

The scope of the present disclosure is defined by the appended claims rather than by the detailed description, and all changes or modifications derived from the meaning and range of the appended claims and equivalents thereof should be construed to be embraced by the scope of the present disclosure.

1. A device of providing an investment value evaluation service, the device comprising:
a preprocessing module that processes financial data for each company or asset collected from a market server to generate training data including figures for each preset financial indicator;
an analysis module that is constructed through the training of a preset machine learning model using the training data to predict a value evaluation index for each company or asset, and output analysis data based on the predicted value evaluation index; and
a service providing module that processes analysis data for a specific company or asset output from the analysis module according to an analysis request from a user terminal to provide investment value evaluation data to the user terminal,
wherein the value evaluation index is a fair price representing an upside potential in the value of a company or asset according to the figures for each financial indicator compared to a current price.

2. The device of claim 1, wherein the preprocessing module acquires figures for at least one financial indicator from among a price earning ratio (PER), a price-to-book ratio (PBR), a price selling ratio (PSR), a price cashflow ratio (PCR), an enterprise value compared to earnings before interest, tax, depreciation, and amortization (EV/EBITDA), a return on equity (ROE), a price earning growth ratio (PEGR), and depositary receipts (DR) for each company or asset through the financial data for each company or asset to set the acquired figures as training data.

3. The device of claim 1, wherein the preprocessing module calculates an arithmetic and weighted average value of operating profit over a preset period for each company or asset through the financial data for each company or asset, and acquires a market sensitive indicator exhibiting a growth potential for each company or asset according to a market situation based on the calculated arithmetic and weighted average to set the market sensitive index as training data.

4. The device of claim 3, wherein the analysis module identifies the development tendencies of each company or asset according to the market sensitive indicator, identifies a user's investment tendencies based on the previously collected user's financial transaction and investment history data, and then outputs user-customized analysis data based on the identified development tendencies and investment tendencies, and
wherein the user-customized analysis data is processed by the service providing module and provided to the user terminal.

5. The device of claim 1, wherein the preprocessing module generates at least one of data on an item price, a supply and demand situation, and a wave analysis basic model for each company or asset through the financial data for each company or asset, and acquires price attractiveness indicating a relative strength of trading reflecting a price trend based on the generated data to set the acquired price attractiveness as training data.

6. The device of claim 5, wherein the analysis module performs backtesting to analyze the user's investment performance through the previously collected user's investment history data, and selects at least one or more items of companies or assets based on a result of the backtesting and the price attractiveness, and
wherein the service providing module provides a user interface for automatic trading, including a function of setting a batch order and trading time condition for at least one of the items selected by the analysis module, to the user terminal.

7. The device of claim 1, wherein the analysis module is designed to include at least one of an analysis algorithm of financial data including preset qualitative factors in the financial statements of each company or asset, an algorithm of analyzing a relative evaluation within the industry to which each company or asset belongs, an algorithm of analyzing the growth potential and stability of each company or asset compared to market capitalization, an algorithm of quantifying, smoothing, and compressing figures for the financial indicator of each company or asset, an analysis algorithm of semi-structured data in the financial data or the training data, and an algorithm of analyzing a relative strength of trading for each company or asset, through the training.

8. The device of claim 1, wherein the service providing module generates an analysis report on the company or asset based on the analysis data to provide the generated analysis report to the user terminal, and
wherein the analysis report comprises an index flow chart reflecting a market situation, detailed diagnostic data on a value evaluation index, a polygonal graph showing figures for each financial indicator and a deviation from an industry average, and detailed diagnostic data on the figures for each financial indicator.

9. The device of claim 1, wherein the service providing module provides a preset question for item filtering to the user terminal, automatically sets search conditions according to an answer from the user terminal to the question to input the search conditions into the preprocessing module, and recommends at least one or more items of companies or assets satisfying the search conditions that are output from the analysis module to the user terminal for each preset cycle.

10. A method of providing an investment value evaluation service using an investment value evaluation service providing device the method comprising,
processing financial data for each company or asset collected from a market server to generate training data including figures for each preset financial indicator;
performing the training of a preset machine learning model using the training data, predicting a value evaluation index for each company or asset on the basis of the training, and outputting analysis data based on the predicted value evaluation index; and
processing analysis data for a specific company or asset output according to an analysis request from a user terminal to provide investment value evaluation data to the user terminal,
wherein the value evaluation index is a fair price representing an upside potential in the value of a company or asset according to the figures for each financial indicator compared to a current price.
